(19) United States
(12) Patent Application Publication
(10) Pub. No.: US 2007/0124994 A1
(43) Pub. Date: Jun. 7, 2007

(54) Real grow bag

(76) Inventor: Adamary Rodriguez, Hialeah, FL (US)

Correspondence Address: Adamary Rodriguez, 580 West 12 Place, Hialeah, FL, 33010, US

(21) Appl. No.: 11/295,176

(22) Filed: Dec. 7, 2005

(51) Int. Cl. A01G 13/02

(52) U.S. Cl. 47/32.7

(57) ABSTRACT

BETTER GROWING PLANTS AND TREES

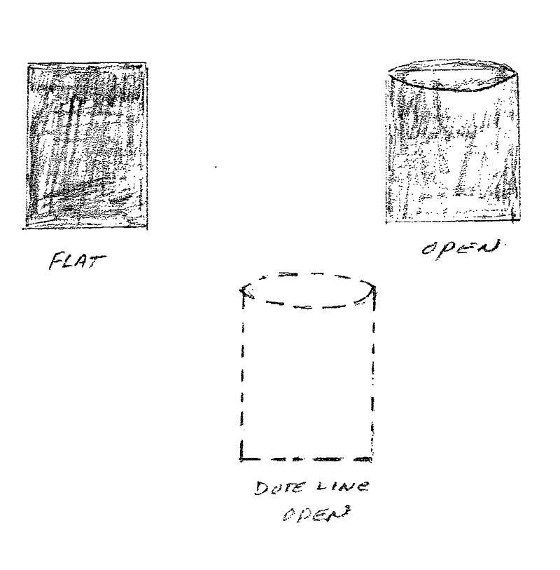

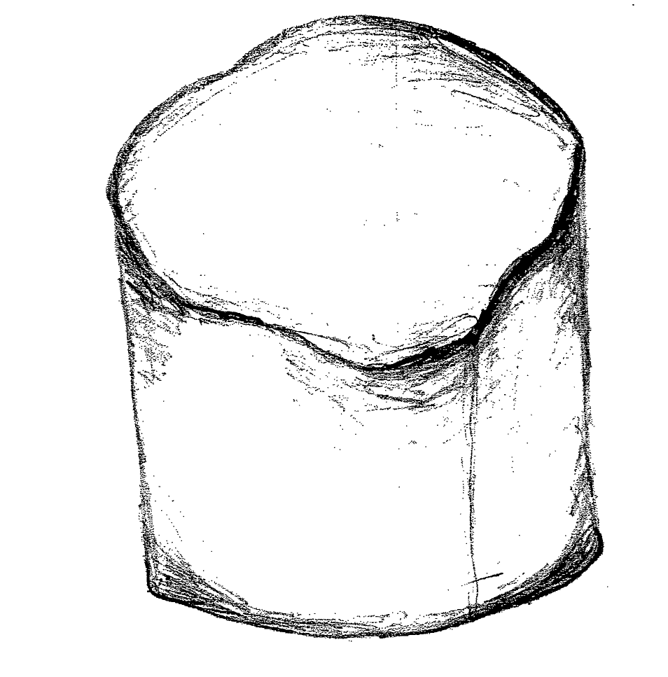

MUST POPULAR SIZE 30 GALLONS SIZE 22″D×19″H, FABRIC USE POLYPROPYLENE, THREAD USE POLYMATIC. POLYPROPYLENE: STRONG MATERIAL GIVE THE BAG A SHAPE. UV & WEATHER RESISTANT POLYMATIC THREAD: UV & WEATHER RESISTANT

PLANTER TECHNOLOGY HAS A TWENTY TO THIRTY YEAR HISTORY OF MAKING POTS AND PLANTERS EASIER AND LESS EXPENSIVE TO MAINTAIN. OUR UNDERSTANDING OF USE OF THE REAL GROW BAGS IS. 1. GROWTH DEVELOPMENT THE ROOT PRUNING IS IMPORTANT TO THE HEATH OF A TRANSPLANTED PLANT. WITH THE REAL GROW BAG APPROXIMATELY 85% OF THE ROOT STRUCTURE IS HARVESTED WITH THE PLANT, WATER AND NUTRIENT ABSORPTION OCCURS NORMALLY BOTH INSIDE AND OUTSIDE THE BAG AT THE ROOT TIPS. THE WATER AND NUTRIENTS ARE TRANSFERRED UP THOUGHT THE CENTER OF THE ROOT, THE XYLEM (THE SUPPORTING AND WATER CONDUCTION TISSUE OF VASCULAR PLANTS). WATER PASS FREELY OUT OF THE REAL GROW BAG. CARBOHYDRATE MANUFACTURED IN THE LEAVES TRAVEL DOWN THE OUTER CAMBIUM LAYER OF THE PLANT, THE PHLOEM (THE FOOD CONDUCTING TISSUE OF VASCULAR PLANTS MADE UP OF SLEVE TUBES AND OTHER CELLULAR MATERIAL). BY USING THE REAL GROWTH BAG YOU CAN ABSORB THE SUN'S RAYS HEATING THE CONTAINS WHICH HELPS THE GROWTH. AND, BY USING THE BAG IT DOSE NOT BURN THE PLANT LIKE PLASTIC POTS CAN. ALSO, IT PROVIDES THE CIRCULATION OF AIR.

2. EASIER TO HANDLE; POTS GET VERY HOT, THE REAL GROWTH BAG NO HEAT ACQUIRERS. THE REAL GROWTH BAG IS EASILY USE D OUT SIDE THE GROUND OR IN THE GROUND. THE REAL GROWTH BAG IS EASY TO DIG. NO EXPENSIVE EQUIPMENT NEEDED TO DIG YOU HARVEST.

3. PRUNING; AUTO ROOT PRUNING, NO MECHANICAL ROOT PRUNING DEVICE IS NEEDED, THE REAL GROWTH BAG NATURALLY ROOT PRUNES A PLANT ALL THE ORDER #968653 TIME THE NATURAL ROOT PRUNING ALSO INDUCES A NATURAL CALLOUSING ON THE ROOT TIP AND BUILDUP OF CARBOHYDRATES IN THE ROOT STRUCTURE ROOT PRUNING, ROOT CALLOUSING, AND CARBOHYDRATE BUILDUP GIVE PLANTS GREAT SURVIVABILITY AT TRANSPLANT AND GOOD GROWTH.

4. ROOT CONTROL; TREES AND SHRUBS ARE PLANTED INTO THE REAL GROWTH BAG, AS THE ROOTS OF THE PLANT GROWS IT HITS THE INSIDE FABRIC OF THE BAG. ROOTS DO NOT CIRCLE ON THE FABRIC AS THEY DO AGAINST PLASTIC. INSTEAD THE ROOT IS CAUGHT BY THE INNER SURFACE OF THE MATERIAL; THE TOUGH FABRIC PREVENTS ROOT FROM EXPANDING. THE ROOT GET CONTAINED BY THE FABRIC, AND THE TIP OF THE ROOT LOOSES IT'S APICAL DOMINANCE AND LATERAL ROOT BRANCHING, OR PRUNING, OCCURS INSIDE THE REAL GROWTH BAG.

5. DURABILITY:FABRIC MATERIAL IS POLYPROPYLENE

THE TREAD USE FOR THE REAL GROW BAG IS A PLYMATTC UV LIGHT, AND IT'S WEATHER RESISTANT.

6. THE BAGS ARE REUSEABLE

THE REAL GROWTH BAG WORKS SIDE BY SIDE WITH ANY FERTILIZATION PRODUCT. BUT THE REAL GROWTH BAG HAS BEEN DESIGNED TO USE THE NATURAL ENVIRONMENT SOURCES SUCH AS WATER MINERALS AND SOIL. BY USING THE REAL GROW BAG YOU WILL DECREASE THE AMOUNT OF FERTILIZATION NEEDED.

SIZE:

SIZE MEASUREMENT: GALLON MEASUREMENT: 16.5″ DIAMETER×21″H 20 GALLONS 20″DIAMETER×20″H 25 GALLONS 22″DIAMETER×19″H 30 GALLONS 23″DIAMETER×19″H 35 GALLONS 24″DIAMETER×22″H 45 GALLONS 31″DIAMETER×20″H 65 GALLONS

AFTER THE FABRIC AND THREAD ARE PUT TOGERTHER IT BECOMES A SHAPE OF A FABRIC BAG

BY SIZE, PLACING A HANDEL, WE MAKE IT DIFFERENTLY THE REAL GROW BAG IS PUT TOGETHER BY DOUBLE LINE THREAD.

Can also HANDEL BUILDING MATERIALS

What is claimed is:

1. HELP PLANTS TO GROW HEATHER AND FASTER THAN PLANTS IN A PLASTIC CONTAINER.
